(19) United States
(12) Patent Application Publication
(10) Pub. No.: US 2007/0221499 A1
(43) Pub. Date: Sep. 27, 2007

(54) Quickly activatable structure of gas sensor element

(75) Inventor: Tooru Katafuchi, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/717,085

(22) Filed: Mar. 13, 2007

(30) Foreign Application Priority Data
Mar. 22, 2006 (JP) 2006-078576

(51) Int. Cl. G01N 27/26

(52) U.S. Cl. 204/424; 204/427

(57) ABSTRACT

A quickly activatable structure of a gas sensor element includes a measurement gas electrode, a reference gas electrode, a solid electrolyte layer to which the measurement and reference gas electrodes are affixed, and a heater. The heater has a heating element to heat the solid electrolyte layer. A reference gas chamber is defined between the solid electrolyte member and the heater and has a length made up of a first chamber and a second chamber. The first chamber is located in a heating area in which the heating element is disposed. The second chamber is located in a non-heating area and has at least a portion which is greater in volume per unit length of the reference gas chamber than the first chamber, thereby decreasing the dissipation of thermal energy to the non-heating area, which enhances the thermal transfer from the heating element to the solid electrolyte member.

### CROSS REFERENCE TO RELATED DOCUMENT

The present application claims the benefit of Japanese Patent Application No. 2006-78576 filed on Mar. 22, 2006, the disclosure of which is totally incorporated herein by reference.

### BACKGROUND OF THE INVENTION

1. Technical Field of the Invention

The present invention relates generally to an improved structure of a gas sensor element which is quickly activatable and may be built in a gas sensor employed in combustion control for automotive internal combustion engines.

2. Background Art

FIG. 34 shows a gas sensor element 9 of a conventional type designed to measure the concentration of a given component of gasses.

The gas sensor element 9 consists essentially of a sensing portion 910 made up of an oxygen ion-conductive solid electrolyte body 911, a measurement gas electrode 912, and a reference gas electrode 913 which are affixed to opposed major surfaces of the solid electrolyte body 911 and a reference gas chamber 93 to which the reference gas electrode 913 is exposed.

In resent years, when employed in measuring the concentration of a specified gas component of exhaust emissions from automotive internal combustion engines, gas sensor elements have been required to be elevated to a desired activation temperature quickly immediately after start-up of the engine in order to ensure the measurement accuracy to operate a burning control mechanism correctly.

In order to meet such a requirement, the gas sensor element 9 is equipped with a heater 940. The heater 940 has a heating element 940 which is to be energized to heat the solid electrolyte body 911 to increase the temperature of the gas sensor element 9 up to the activation temperature quickly.

The reference gas electrode 913 is, as described above, exposed to the reference gas chamber 93. For defining the reference gas chamber 93, a spacer 13 is interposed between the solid electrolyte body 911 and the heater 940. The thermal energy, as produced by the heater 940, is therefore transmitted to the solid electrolyte body 911 through the spacer 915. Increasing the volume of the reference gas chamber 93 may result in a lack of the amount of the thermal energy transmitted to the solid electrolyte body 911.

The reference gas chamber 93 extends to a base end of the gas sensor element 9 at which air is admitted thereinto as a reference gas. Decreasing the volume of the reference gas chamber 93 will facilitate ease of the transmission of thermal energy from the heater 940 to the solid electrolyte body 911, but however, result in an increase in resistance to the entrance of air into the reference gas chamber 93, thus leading to decreased accuracy of output of the gas sensor element 9.

There have been also proposed gas sensor elements equipped with no reference gas chamber. In this type of gas sensor elements, however, the heat will transfer from the heater to the end of the reference gas chamber as well as to the solid electrolyte body, which may result in a delay in activating the solid electrolyte body.

Japanese Patent First Publication Nos. 7-301616, 7-333194, and 8-114571 disclose the above discussed types of gas sensor elements.

### SUMMARY OF THE INVENTION

It is therefore a principal object of the present invention to avoid the disadvantages of the prior art.

It is another object of the present invention to provide an improved structure of a gas sensor element capable of being activated quickly.

According to one aspect of the invention, there is provided a gas sensor element which may be built in an O₂, A/F, NOx, or HC sensor to be installed in an exhaust pipe of an automotive engine. The gas sensor element comprises: (a) an oxygen ion conductive solid electrolyte member; (b) a measurement gas electrode which is affixed to one of opposed surfaces of the solid electrolyte member and exposed to a gas to be measured; (c) a reference gas electrode affixed to the other of the opposed surfaces of the solid electrolyte member; (d) a heater equipped with a heating element working to heat the solid electrolyte member; and (e) a reference gas chamber defined between the solid electrolyte member and the heater. The reference gas chamber being filled with a reference gas to which the reference gas electrode is exposed. The reference gas chamber has a length made up of a first chamber and a second chamber. The first chamber is located in a heating area in which the heating element of the heater is disposed. The second chamber is located in a non-heating area and has at least a portion which is greater in volume per unit length of the reference gas chamber than the first chamber. This minimizes the dissipation of thermal energy from the heating area to the non-heating area to decrease the amount of the thermal energy transmitted from the non-heating area to the solid electrolyte member, thereby enhancing the transfer of the thermal energy from the heating element to the solid electrolyte member, thus improving the efficiency in heating the solid electrolyte member to ensure the stability of quick activation of the gas sensor element.

In the preferred mode of the invention, the first chamber has a maximum transverse sectional area which is smaller than that of the second chamber.

The first chamber may be so designed that an average of transverse sectional areas along a length of the first chamber is smaller than that of the second chamber.

According to another aspect of the invention, there is provided a gas sensor element which comprises: (a) an oxygen ion conductive solid electrolyte member; (b) a measurement gas electrode which is affixed to one of opposed surfaces of the solid electrolyte member and exposed to a gas to be measured; (c) a reference gas electrode affixed to the other of the opposed surfaces of the solid electrolyte member; (d) a heater equipped with a heating element working to heat the solid electrolyte member; and (e) a chamber defined between the solid electrolyte member and the heater. The chamber is located in a non-heating area which lies outside a heating area in which the heating element of the heater is disposed. This enhances the transfer of the thermal energy from the heating element to the solid electrolyte member, thus improving the efficiency in heating the solid electrolyte member to ensure the stability of quick activation of the gas sensor element.

In the preferred mode of the invention, the gas sensor element further comprises a pumping reference function working to feed a reference gas to the reference gas electrode through the solid electrolyte member.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partially longitudinal sectional view which shows the layout of a heater in a gas sensor element according to the first embodiment of the invention;

FIG. 2 is a transverse sectional view taken along the line A-A in FIG. 1;

FIG. 3 is a transverse sectional view taken along the line B-B in FIG. 1;

FIG. 4 is a longitudinal sectional view which shows a reference gas chamber formed in the gas sensor element of FIG. 1;

FIG. 5 is an exploded view which shows the gas sensor element of FIG. 1;

FIG. 6(a) is a top view which shows the gas sensor element of FIG. 5;

FIG. 6(b) is a longitudinal sectional view which shows the layout of a heater in the gas sensor element of FIG. 5;

FIG. 6(c) is a side view of the gas sensor element of FIG. 5;

FIG. 7(a) is a longitudinal sectional view which shows a reference gas chamber form in a gas sensor element according to the second embodiment of the invention;

FIG. 7(b) is a side view of the gas sensor element of FIG. 7(a);

FIG. 8 is a transverse sectional view taken along the line A-A in FIG. 7(a);

FIG. 9 is a transverse sectional view taken along the line B-B in FIG. 7(b);

FIG. 10 is a longitudinal sectional view which shows a reference gas chamber form in a gas sensor element according to the third embodiment of the invention;

FIG. 11 is a transverse sectional view taken along the line A-A in FIG. 10;

FIG. 12 is a transverse sectional view taken along the line B-B in FIG. 10;

FIG. 13 is a longitudinal sectional view which shows a reference gas chamber form in a gas sensor element according to the fourth embodiment of the invention;

FIG. 14 is a transverse sectional view taken along the line A-A in FIG. 13;

FIG. 15 is a transverse sectional view taken along the line B-B in FIG. 13;

FIG. 16 is a longitudinal sectional view which shows a reference gas chamber form in a gas sensor element according to the fifth embodiment of the invention;

FIG. 17 is a transverse sectional view taken along the line A-A in FIG. 16;

FIG. 18 is a transverse sectional view taken along the line B-B in FIG. 16;

FIG. 19 is a longitudinal sectional view which shows a reference gas chamber form in a gas sensor element according to the sixth embodiment of the invention;

FIG. 20 is a transverse sectional view taken along the line A-A in FIG. 19;

FIG. 21 is a transverse sectional view taken along the line B-B in FIG. 19;

FIG. 22(a) is a longitudinal sectional view which shows a reference gas chamber form in a gas sensor element according to the seventh embodiment of the invention;

FIG. 22(b) is a side view of the gas sensor element of FIG. 22(a);

FIG. 23 is a transverse sectional view taken along the line A-A in FIG. 22(a);

FIG. 24 is a transverse sectional view taken along the line B-B in FIG. 22(b);

FIG. 25 is a transverse sectional view taken along the line A-A in FIG. 27;

FIG. 26 is a transverse sectional view taken along the line B-B in FIG. 27;

FIG. 27 is a top view which shows a gas sensor element according to the eighth embodiment of the invention;

FIG. 28 is a transverse sectional view which shows a top end portion of a gas sensor element according to the ninth embodiment of the invention;

FIG. 29 is perspective view which shows how to make reference gas chambers in green sheet according to the tenth embodiment of the invention;

FIG. 30 is a partially side view of FIG. 29;

FIG. 31 is a transverse sectional view which shows how to make reference gas chambers in green sheet according to the eleventh embodiment of the invention;

FIGS. 32(a), 32(b), and 32(c) are longitudinal sectional views which show different types of test samples used to measure the time required for activating the samples;

FIGS. 33(a) and 33(b) are longitudinal sectional views which show different types of test samples used to measure the time required for activating the samples;

FIG. 34 is a transverse sectional view which shows a top end portion of a conventional gas sensor element; and

FIG. 35 is a transverse sectional view which shows a base end portion of the gas sensor of FIG. 34.

### DESCRIPTION OF THE PREFERRED EMBODIMENTS

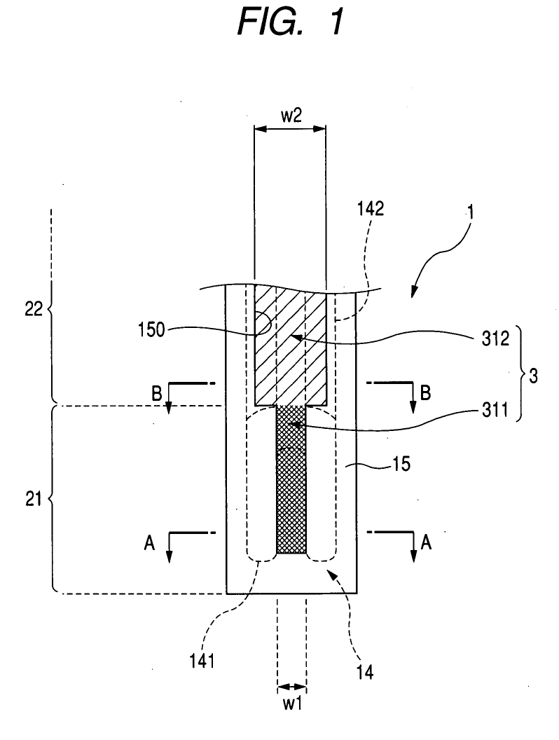

Referring now to the drawings, wherein like numbers refer to like parts in several views, particularly to FIGS. 1 to 6, there is shown a gas sensor element 1 according to the first embodiment of the invention. The gas sensor element 1 is to be built in an O₂, A/F, NOx, or HC sensor which may be installed in an exhaust pipe of an automotive engine. An overall structure of such a gas sensor is not essential for this invention, and explanation thereof in detail will be omitted here.

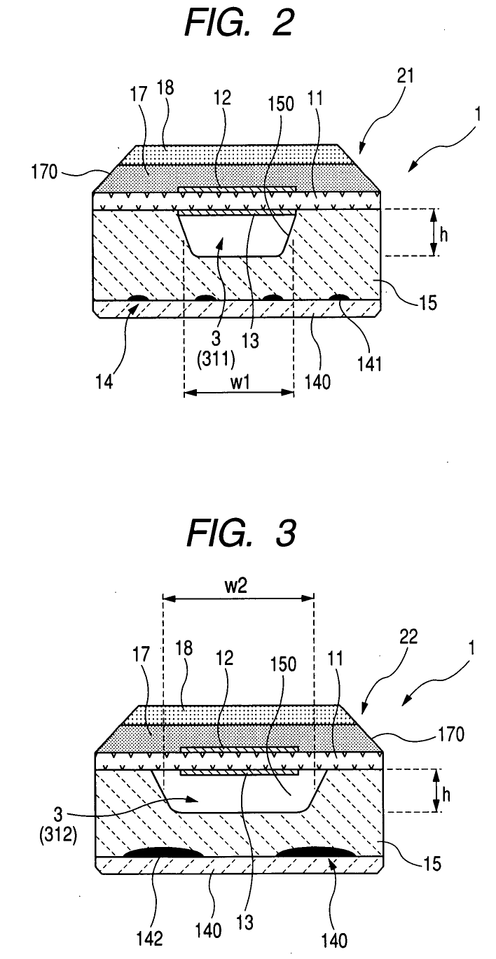

The gas sensor element 1 includes, as shown in FIGS. 2, 3, and 5, an oxygen ion-conductive solid electrolyte layer 11, a measurement gas electrode 12, a reference gas electrode 13, and a heater 14. The measurement gas electrode 12 and the reference gas electrode 13 are affixed to opposed surfaces of the solid electrolyte layer 11 to form an electrochemical cell. The heater 14 is equipped with a heating element 141 which works to heat the solid electrolyte layer 11 up to a selected temperature.

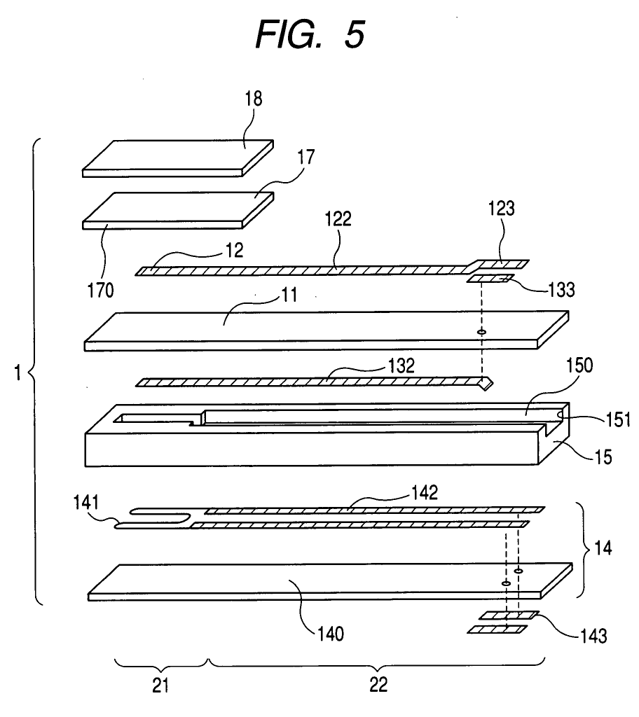

The gas sensor element 1 also has, as shown in FIGS. 1 to 3, and 5, a reference gas chamber 3 defined between the solid electrolyte layer 11 and the heater 14. In use of the gas sensor element 1, the reference gas chamber 3 is filled with air entering from outside the gas sensor element 1. The heating element 141 of the heater 14, as clearly shown in FIG. 5, connects at ends thereof with leads 142 extending in a lengthwise direction of the gas sensor element 1. The heating element 141 and the leads 142 are disposed on a heater substrate 140 along the length of the gas sensor element 1 to define a heating area 21 and a non-heating area 22. The reference gas chamber 3 is, as clearly illustrated in FIGS. 2 and 3, made up of a small-volume section 311 defined in the heating area 21 and a large-volume section 312 defined in the non-heating area 22. The small-volume section 311 has a maximum cross sectional area which extends perpendicular to the length of the gas sensor element 1 and is smaller in size than that of the large-volume section 312 extending perpendicular to the length of the gas sensor element 1. The small-volume section 311 and the large-volume section 312 will also be referred to below as a first reference gas chamber and a second reference gas chamber, respectively.

The gas sensor element 1, as described above, may be employed in O₂, A/F, NOx or HC sensors.

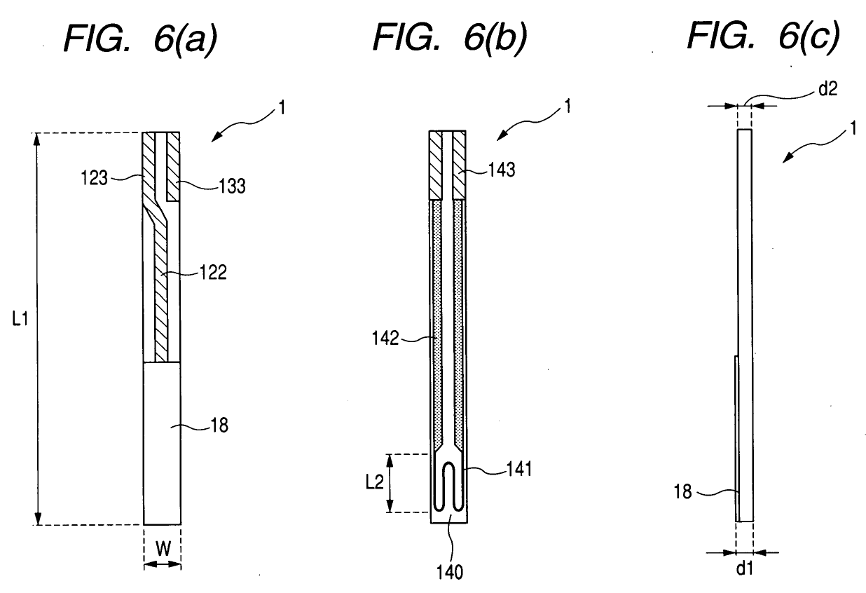

The gas sensor element 1, as illustrated in FIGS. 2, 3, and 5, has the measurement gas electrode 12 affixed to one of opposed major surfaces of the solid electrolyte layer 11. The measurement gas electrode 12 is made of platinum and, as illustrated in FIGS. 5 and 6(a), connects at a base end thereof with a lead 122. The lead 122 connects with a terminal 123 from which a sensor signal is outputted.

The gas sensor element 1, as illustrated in FIGS. 2, 3, and 5, has the reference gas electrode 12 affixed to the other major surface of the solid electrolyte layer 11. The reference gas electrode 13 is made of platinum and, as illustrated in FIGS. 5 and 6(a), connects at a base end thereof with a lead 132. The lead 132 connects through a conductive material-coated hole with a terminal 133 from which a sensor signal is outputted. The solid electrolyte layer 11, as illustrated in FIGS. 2, 3, and 5, is stacked on a spacer layer 15 which is made of an electrically insulating dense gas impermeable alumina ceramics. The spacer layer 15, as illustrated in FIGS. 1 to 5, has a groove 150 which defines the reference gas chamber 3 along with the solid electrolyte layer 11.

The first reference gas chamber 311 defined within the heating area 21 and the second reference gas chamber 312 defined within the non-heating area 22, as can be seen in FIGS. 2 and 3, have the same constant height h in a thickness-wise direction of the gas sensor 1 (i.e., a direction in which the solid electrolyte layer 11, the spacer layer 15, and the heater substrate 140 are stacked).

The first reference gas chamber 311, as shown in FIG. 2, has a width w1 which is constant in the lengthwise direction of the spacer layer 15. Similarly, the second reference gas chamber 312, as shown in FIG. 3, has a width w2 which is constant in the lengthwise direction of the spacer layer 15. The width w1, as referred to here, is the distance between middle points on oblique sides of a transverse cross section of the first reference gas chamber 311 which extends perpendicular to the length thereof. The same is true for the width w2.

Since cross-sectional areas of the first reference gas chamber 311 and the second reference gas chamber 312 are constant in the lengthwise direction of the spacer layer 15, they will be the maximum sectional areas thereof, as expressed by h×w1 and h×w2, respectively. They will also be identical with averages of sectional areas of the first and second reference gas chambers 311 and 312 along the lengths thereof, respectively. Since, as illustrated in FIGS. 1 to 5, the width w1 of the first reference gas chamber 311 is smaller than the width w2 of the second reference gas chamber 312 (i.e., w1<w2), the maximum sectional area or the average sectional area of the first reference gas chamber 311 (h×w1) is smaller than the maximum sectional area or the average sectional area of the second reference gas chamber 312 (h×w2).

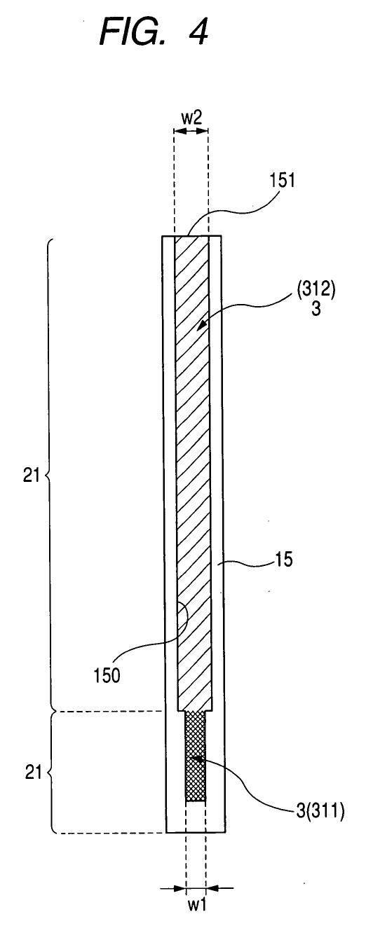

The reference gas chamber 3, as can be seen from FIGS. 4 and 5, has an opening 151 at the base end thereof which is exposed outside the gas sensor element 1 so that air is admitted directly into the reference gas chamber 3 as a reference gas. Specifically, the air enters at the opening 151, goes to the first reference gas chamber 311 through the second reference gas chamber 312, and reaches the reference gas electrode 13.

The gas sensor element 1, as shown in FIGS. 2, 3, and 5, also includes a porous diffusion resistance layer 17 and a shield layer 18. The porous diffusion resistance layer 17 is made of alumina and disposed on the surface of the solid electrolyte layer 11 through the measurement gas electrode 12. The shield layer 18 is made of alumina and dense enough to block the transmission of gas therethrough. The shield layer 18 is disposed on the porous diffusion resistance layer 17. The gas to be measured (which will also be referred to as measurement gas below) is introduced from an outer side surface 170 of the porous diffusion resistance layer 17 and goes to the measurement gas electrode 12.

The heater substrate 140 is, as described above, disposed on the spacer layer 15. The heating element 141 and the leads 142 are affixed to the heater substrate 140 in direct contact with the spacer layer 15. The leads 142 connect with terminals 143 through conductive material-coated holes formed in the heater substrate 140. The heating element 141 is supplied with electric power from an external source through the terminals 143 and the leads 142.

When energized electrically, the heating element 141 heats the spacer layer 15 to transmit the thermal energy to the solid electrolyte layer 11 and activates it. When the temperature of the solid electrolyte layer 11 reaches the activation temperature, it will cause an electrical current to flow between the measurement gas electrode 12 and the reference gas electrode 13 as a function of a difference in concentration of oxygen between the measurement gas and the reference gas. The electrical current is typically sampled by an external device to determine the concentration of oxygen (O₂), for example.

The gas sensor element 1 has, as illustrated in FIG. 6(a), a length L1 of 46 mm and a width W of 4.5 mm. The heating element 141, as illustrated in FIG. 6(b), a length L2 of 6.0 mm extending in the lengthwise direction of the gas sensor 1. The gas sensor element 1 has, as illustrated in FIG. 6(c), a thickness d1 of 2.0 mm at the top end thereof and a thickness d2 of 1.6 mm at the base end thereof. In this case, the width w1 of the first reference gas chamber 311 may be within a range of 0.3 to 1.0 mm. The width w2 of the second reference gas chamber 312 may be within a range of 1.0 to 3.0 mm.

The feature of the structure of the gas sensor element will be described below.

The maximum transverse sectional area (h×w1) of the first reference gas chamber 311 within the heating area 21 is, as already described within reference to FIGS. 1 to 5, smaller than the maximum transverse sectional area (h×w2) of the second reference gas chamber 312 within the non-heating area 22. In other words, the second reference gas chamber 312 is designed to be greater in volume per unit length of the reference gas chamber 3 than the first reference gas chamber 311, thereby minimizing the dissipation of thermal energy from the heating area 21 to the non-heating area to decrease the amount of the thermal energy transmitted from the non-heating area 22 to the solid electrolyte layer 11. This enhances the transfer of the thermal energy from the heating element 141 to the solid electrolyte layer 11, thus improving the efficiency in heating the solid electrolyte layer 11 to ensure the stability of quick activation of the gas sensor element 1.

The second reference gas chamber 312 may be designed to have at least a portion which is greater in volume per unit length of the reference gas chamber 3 than the first reference gas chamber 311.

The gas sensor element 1 may alternatively be designed to have a measurement gas chamber filled with the measurement gas such as one, as denoted at reference number 19 in FIG. 25, to which the measurement gas electrode 12 is exposed. Instead of the opening 151 of the reference gas chamber 3, the solid electrolyte layer 11 may have a through hole as an air inlet through which air is admitted into the reference gas chamber 3.

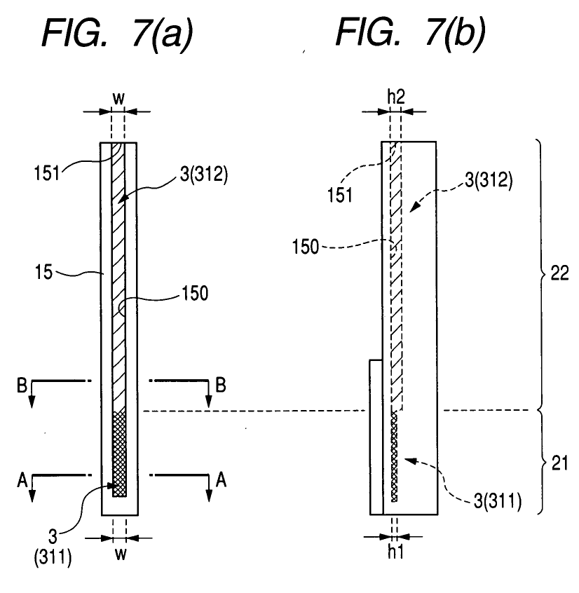

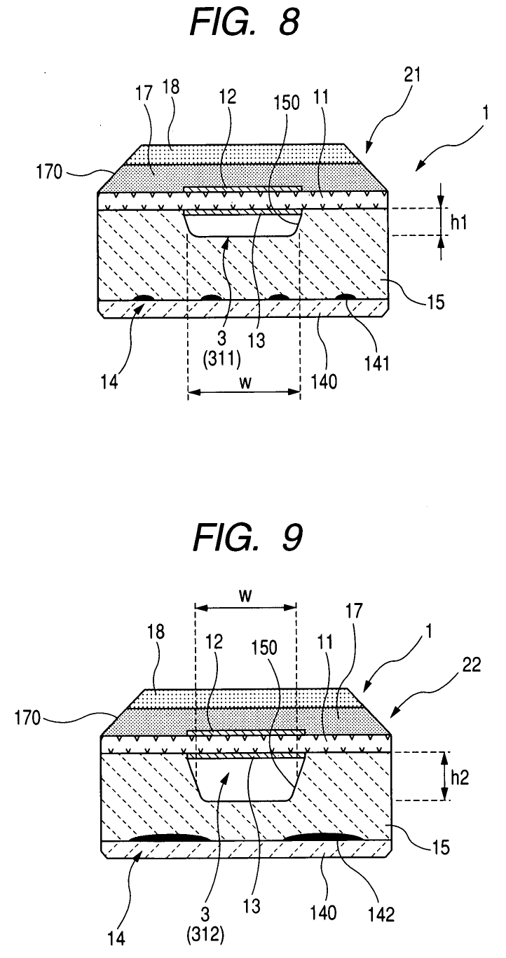

FIGS. 7(a) to 9 illustrate the gas sensor element 1 according to the second embodiment of the invention which is different from the first embodiment in that the height h1 of the first reference gas chamber 311 in the heating area 21 is smaller than the height h2 of the second reference gas chamber 312 in the non-heating area 22, and the heights h1 and h2 are constant along the length of the spacer layer 15. The width w of the first reference gas chamber 311 is identical with that of the second reference gas chamber 312. The widths w of the first and second reference gas chambers 311 and 312 are constant along the length of the spacer layer 15. Other arrangements and operations are identical with those in the first embodiment, and explanation thereof in detail will be omitted here.

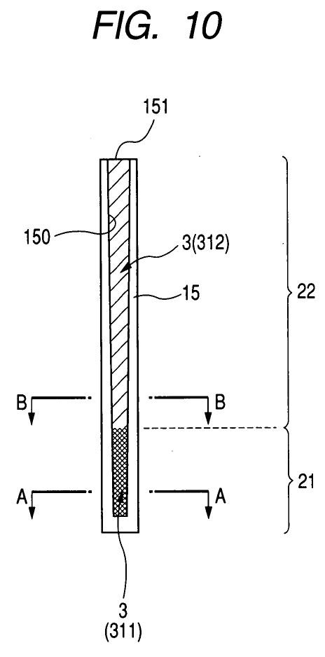

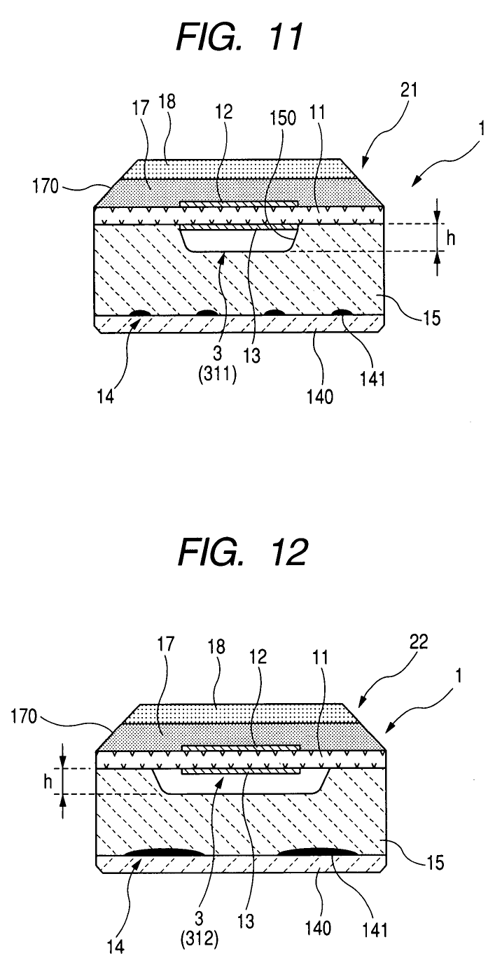

FIGS. 10 to 12 illustrate the gas sensor element 1 according to the third embodiment of the invention which is different from the first embodiment in that the reference gas chamber 3 is so shaped as to taper toward the end of the first reference gas chamber 311. The height h of the reference gas chamber 3 is constant along the overall length thereof. Other arrangements and operations are identical with those in the first embodiment, and explanation thereof in detail will be omitted here.

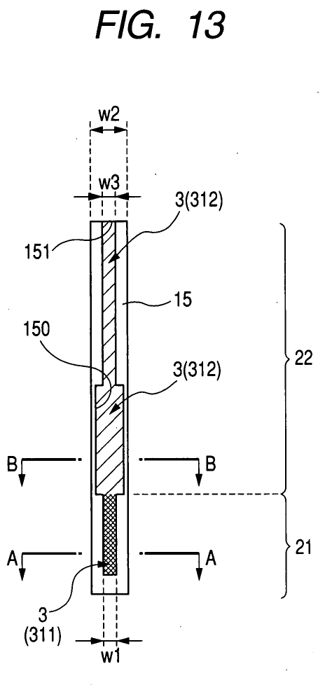

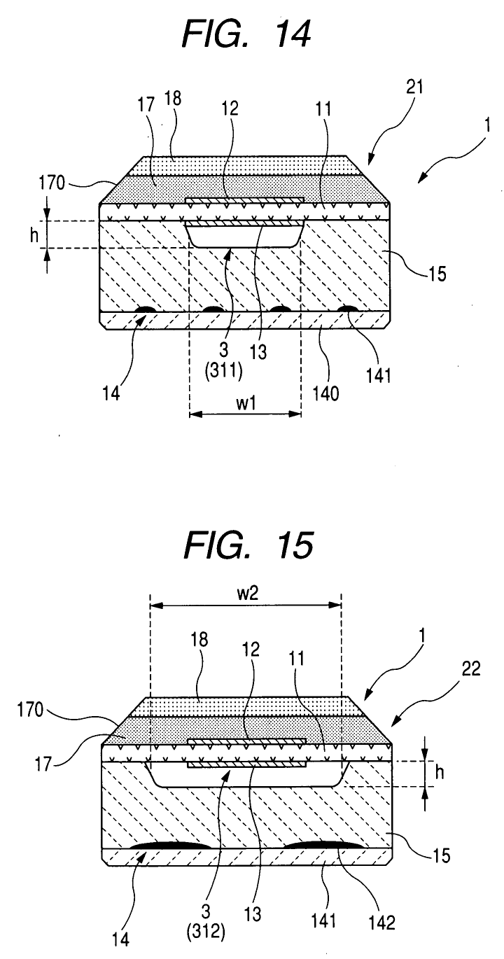

FIGS. 13 to 15 illustrate the gas sensor element 1 according to the fourth embodiment of the invention which is different from the first embodiment in that the second reference gas chamber 312 includes a large-volume portion adjacent the first reference gas chamber 311 which has, as clearly shown in FIG. 15, a width w2 greater than a width w1 of the first reference gas chamber 311. The second reference gas chamber 312 includes a small-volume portion whose width w3 is identical with the width w1 of the first reference gas chamber 311.

The height h of the reference gas chamber 3 is constant along the overall length thereof. Other arrangements and operations are identical with those in the first embodiment, and explanation thereof in detail will be omitted here.

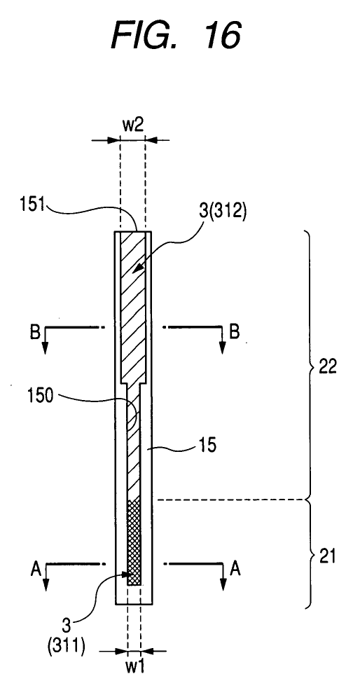

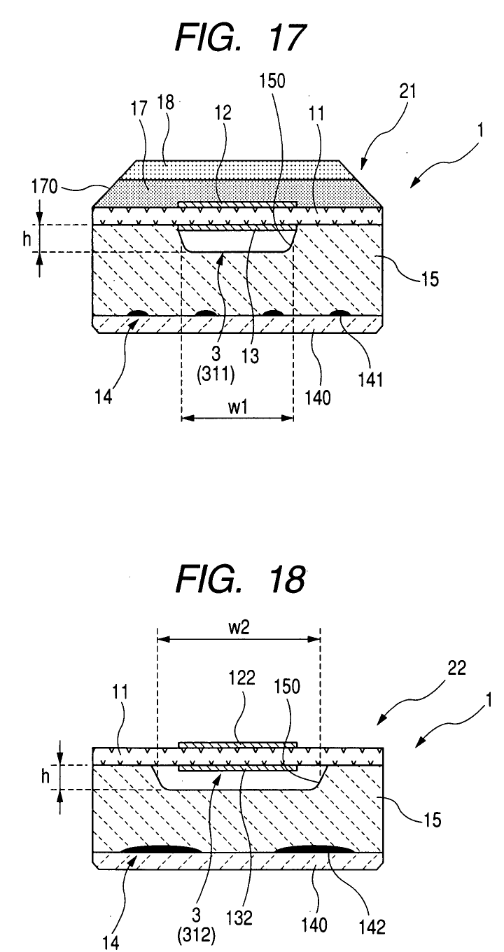

FIGS. 16 to 18 illustrate the gas sensor element 1 according to the fifth embodiment of the invention which is a modification of the fourth embodiment. The second reference gas chamber 312 has a large-volume portion defined on the side of the base end thereof and a small-volume portion defined adjacent the first reference gas chamber 311. The large-volume portion has a width w2 greater than a width w1 of the first reference gas chamber 311. The small-volume portion of the second reference gas chamber 312 has the width identical with the width w1 of the first reference gas chamber 311. Other arrangements and operations are identical with those in the fourth embodiment, and explanation thereof in detail will be omitted here.

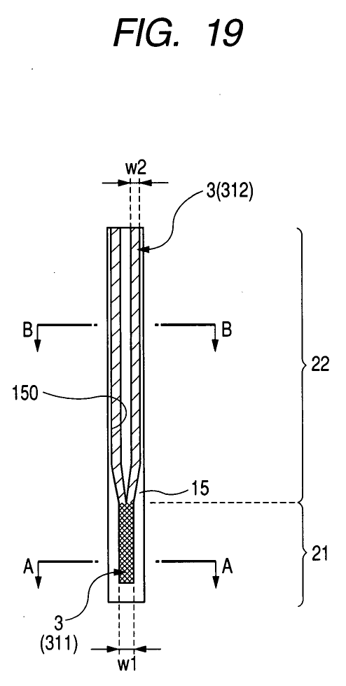

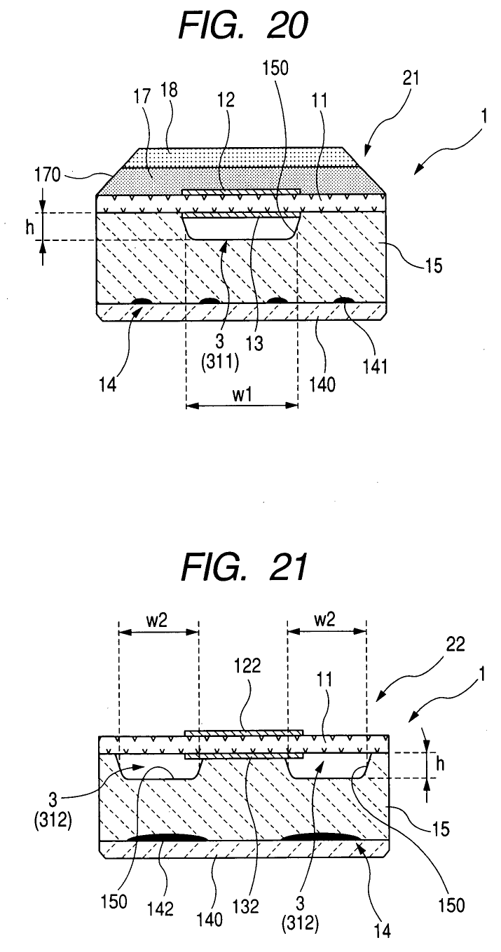

FIGS. 19 to 21 illustrate the gas sensor element 1 according to the sixth embodiment of the invention which is different from the first embodiment in that the second reference gas chamber 312 is made up of two discrete ducts which extend from the base end (i.e., an upper end, as viewed in FIG. 19) of the spacer layer 15 in parallel to each other along the length of the gas sensor element 1, meet, and connect with the first reference gas chamber 311. The joint of the two ducts with the first reference gas chamber 311 is located at or near the interface between the heating area 21 and the non-heating area 22. The two ducts have, as can be seen from FIG. 21, the same width w2.

The height h of the reference gas chamber 3 is constant along the overall length thereof.

The sum of transverse sectional areas of the two ducts of the second reference gas chamber 312 which extend perpendicular to the length of the gas sensor element 1 is given by 2×h×w2 which is greater than the transverse sectional area (h×w1) of the first reference gas chamber 311. The transverse sectional area (h×w2) of each of the two ducts of the second reference gas chamber 311 is smaller than the transverse sectional area (h×w1) of the first reference gas chamber 311. Other arrangements and operations are identical with those in the first embodiment, and explanation thereof in detail will be omitted here.

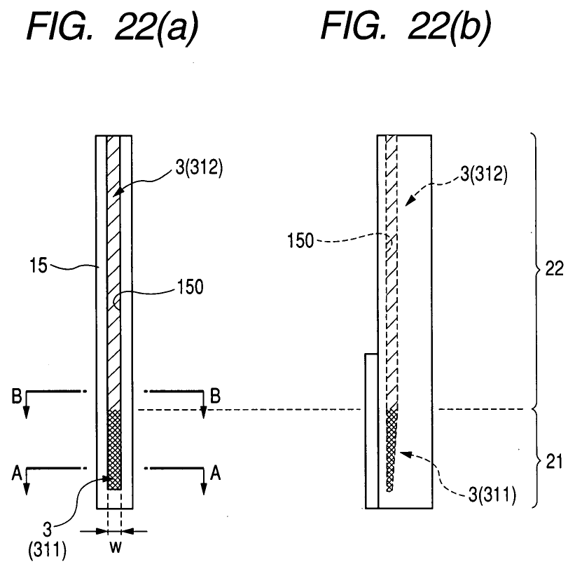

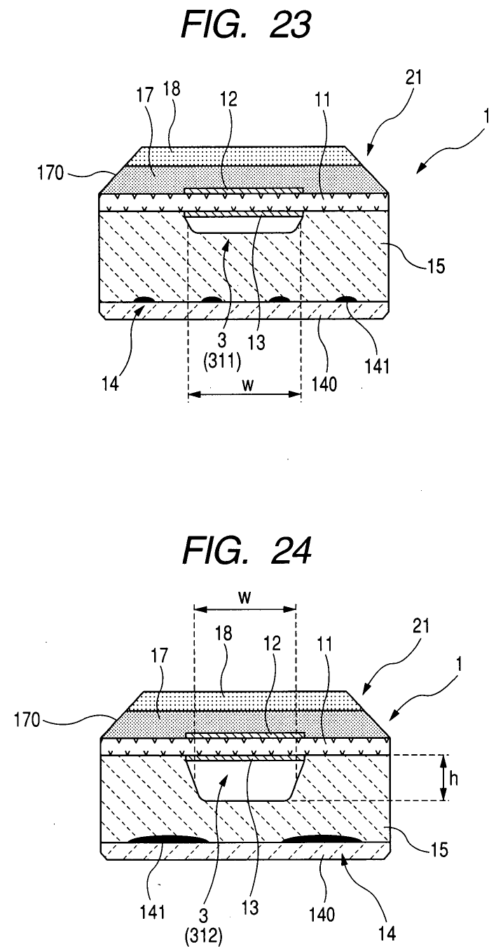

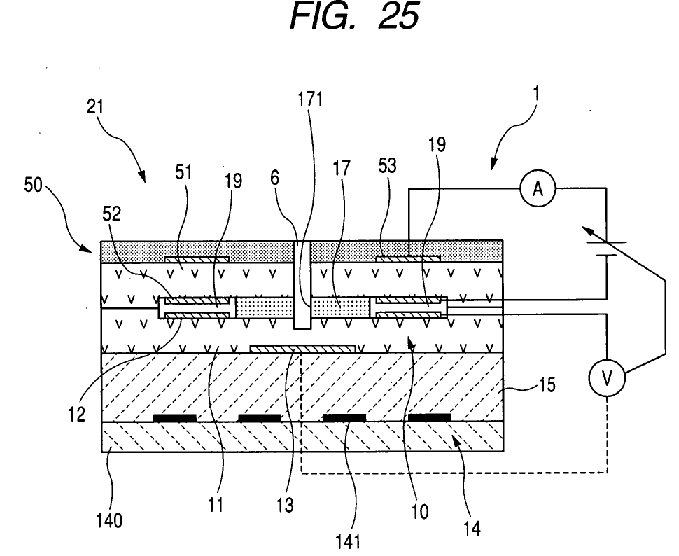

FIGS. 22(a) to 24 illustrate the gas sensor element 1 according to the seventh embodiment of the invention. The first reference gas chamber 311 is identical in width w with the second reference gas chamber 312. The height h of the second reference gas chamber 312 is constant along the length thereof. The first reference gas chamber 311, as clearly illustrated in FIG. 22(b), tapers to the top end (i.e., a lower end, as viewed in FIGS. 22(a) and 22(b)) of the spacer layer 15. Specifically, the height of the first reference gas chamber 311 decreases from the interface between the heating area 21 and the non-heating area 22. Other arrangements and operations are identical with those in the first embodiment, and explanation thereof in detail will be omitted here.

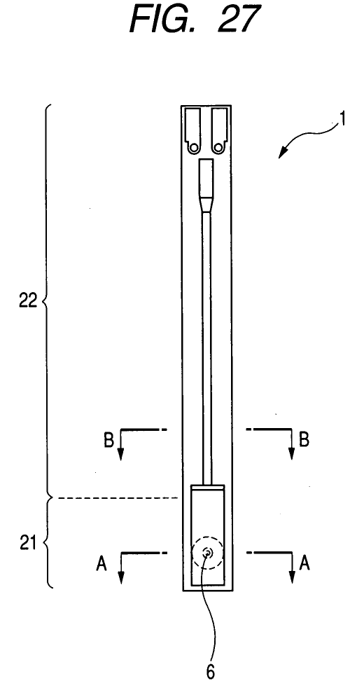

FIGS. 25 to 27 show the gas sensor element 1 according to the eighth embodiment of the invention which has a two-cell structure including a sensor cell 10 working to measure the concentration of oxygen (O₂) contained in, for example, exhaust emissions of automotive engines and a pump cell 50 working to pump oxygen into or out of the measurement gas chamber 19.

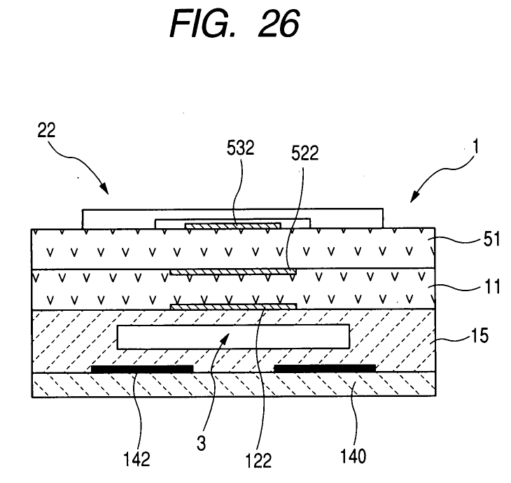

The reference gas chamber 3 is, as illustrated in FIG. 26, defined to occupy only the non-heating area 22.

The sensor cell 10, as shown in FIG. 25, consists of the solid electrolyte layer 11, the measurement gas electrode 12, and the reference gas electrode 13 which are affixed to opposed major surfaces of the solid electrolyte layer 11. The measurement gas electrode 12 is exposed to the measurement gas chamber 19.

The measurement gas electrode 12 connects at the base end thereof to the lead 122, as shown in FIG. 26, from which a sensor signal is outputted.

The pump cell 50, as shown in FIG. 25, consists of the solid electrolyte layer 51 and a pair of pump electrodes 52 and 53 affixed to opposed major surfaces of the solid electrolyte layer 51. The pump electrode 52 is exposed to the measurement gas chamber 19.

The pump electrodes 52 and 53 are connected at base ends thereof to the leads 522 and 532, respectively, from which sensor signals are outputted.

The gas sensor element 1 also has formed therein a gas inlet hole 6 through which the measurement gas is introduced from outside the gas sensor element 1 into the measurement gas chamber 19. The gas inlet hole 6 extends through the solid electrolyte layer 51 and the porous diffusion resistance layer 17.

The measurement gas enters the gas inlet hole 6 and goes to the measurement gas chamber 19 through the side surface 171 of the porous diffusion resistance layer 17.

The sensor cell 10 works to pump oxygen out of the measurement gas chamber 19 and feed it to the reference gas electrode 13.

In operation, the gas sensor element 1 works to produce between the measurement gas electrode 12 and the reference gas electrode 13 an electromotive force as a function of a difference in concentration of oxygen between the surface of the reference gas electrode 13 and the measurement gas chamber 19. When the electromotive force is shifted from a given value, a sensor controller applies a selected level of voltage across the pump electrodes 52 and 53 of the pump cell 50 to pump oxygen out of or into the measurement gas chamber 19 to keep the concentration of oxygen within the measurement gas chamber 19 constant. This causes an oxygen ion current that is a function of the concentration of oxygen in the measurement gas to be developed between the pump electrodes 52 and 53. Other arrangements and operations are identical with those in the second embodiment, and explanation thereof in detail will be omitted here.

FIG. 28 illustrates the gas sensor element 1 according to the ninth embodiment of the invention which has a two-cell structure including the pump cell 50 and the sensor cell 10. The heating element 14 is located closer to the pump cell 50 than the sensor cell 10. The porous diffusion resistance layer 17 is arrayed to surround the measurement gas chamber 19.

The reference gas chamber 3 is formed on one of the surfaces of the solid electrolyte layer 11 which is opposite the measurement gas chamber 19. Other arrangements are identical with those in the eighth embodiment, and explanation thereof in detail will be omitted here.

The spacer layer 15 may have formed in the base end thereof an opening (not shown) through which air is introduced into the reference gas chamber 3.

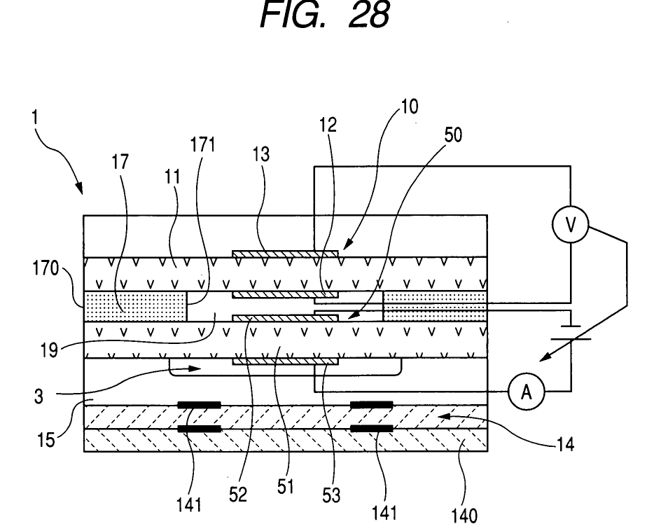

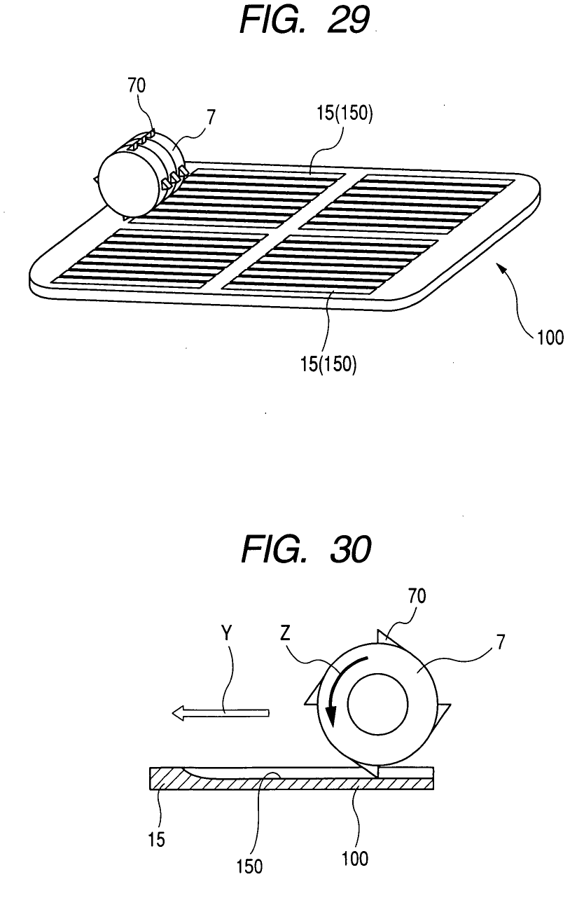

FIGS. 29 and 30 illustrate how to make a plurality of spacer layers 15 using a cutting machine according to the tenth embodiment of the invention.

First, the green sheet 100 is, as shown in FIG. 29, formed using a doctor blade or extrusion molding techniques. Next, a plurality of grooves 150 are formed in the green sheet 100 using the cutting machine 7 with cutters 70. Each of the grooves 150 defines the first and second reference gas chambers 311 and 312 within the heating area 21 and the non-heating area 22.

The formation of the grooves 150 is achieved, as shown in FIG. 30, by moving the cutting machine 7 in a direction, as indicated by an arrow Y, while rotating the cutters 70 in a direction, as indicated by an arrow Z.

The configurations of the first and second reference gas chambers 311 and 312 may be changed by exchanging the cutters 70.

The green sheet 100 is stacked on other layers, cut into a plurality of strips, and then fired to make a plurality of gas sensor elements 1.

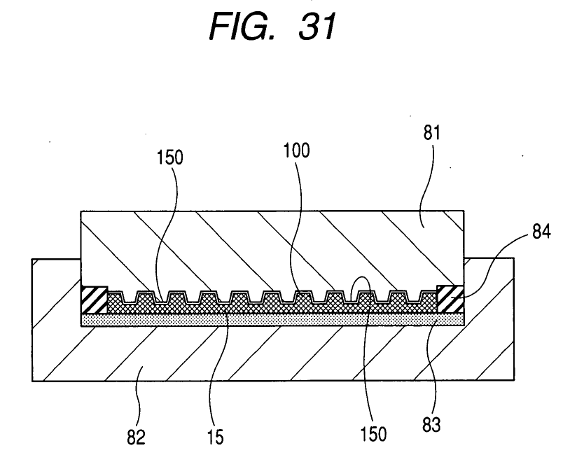

FIG. 31 illustrates how to make a plurality of spacer layers 15 using a press machine according to the eleventh embodiment of the invention.

First, the green sheet 100 is placed on the lower die 82 through Teflon (registered trade mark) sheet 83. A rubber gasket 84 is fitted around the green sheet 100. Next, the green sheet 100 is pressed using the upper die 81 to form a plurality of grooves 150 of a desired configuration. Other production steps are identical with those in the tenth embodiment.

The inventor of this application performed tests to evaluate the time required to activate the gas sensor element 1.

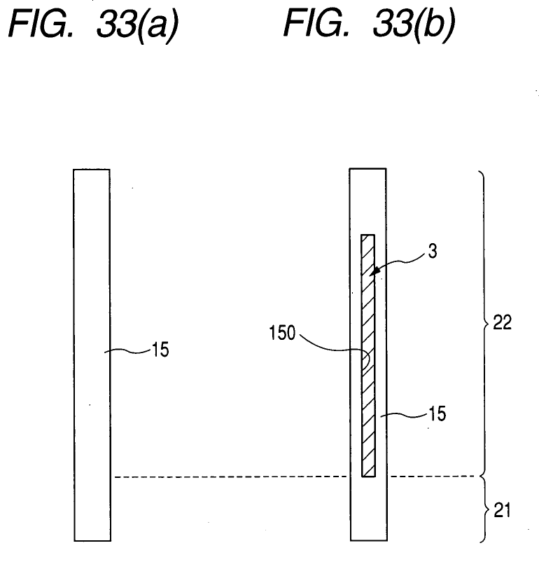

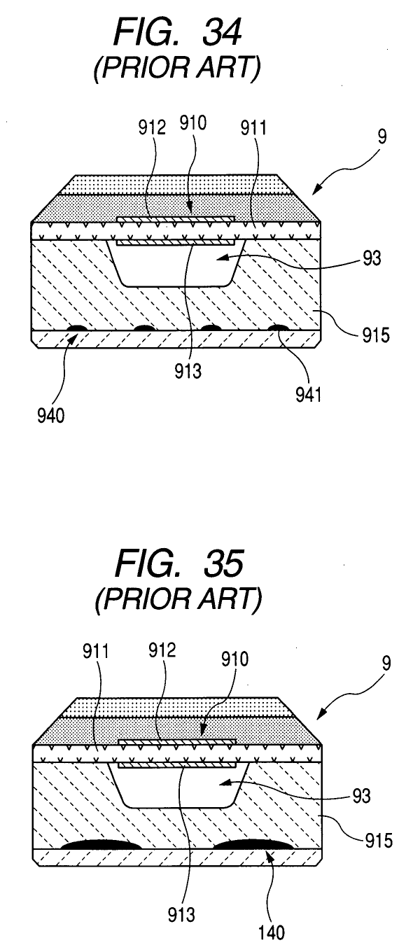

First, test samples were prepared which had, as illustrated in FIGS. 33(a), 33(b), and 33(c), different sectional areas of the reference gas chamber 3. Each of the test samples was heated to measure the time (will also be referred to as an activation time below) required for the test sample to reach a desired activation temperature of 650° C.

In each of the test samples, the reference gas chamber 3 is made up of the first reference gas chamber 311 in the heating area 21 and the second reference gas chamber 312 in the non-heating area 22. The test samples were prepared which had different transverse sectional areas of the first and second gas chambers 311 and 312.

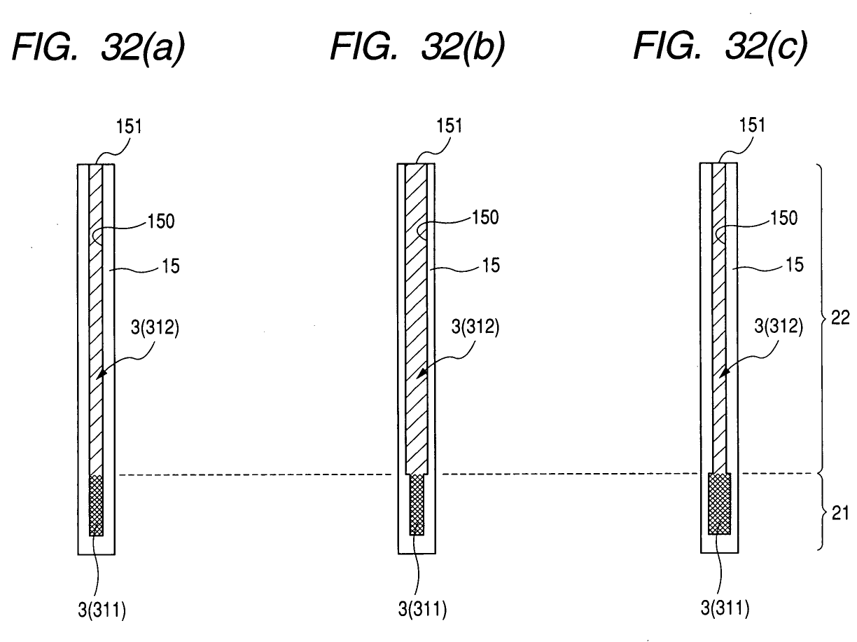

FIG. 32(a) illustrates the test sample No. 1 having a conventional structure in which the first and second reference gas chambers 311 and 312 have the same transverse sectional area. FIG. 32(b) illustrates each of the test samples No. 2 to No. 4 in which the first reference gas chamber 311 is smaller in transverse sectional area than the second reference gas chamber 312. FIG. 32(c) illustrates each of the test samples No. 5 to No. 7 in which the first reference gas chamber 311 is, unlike the gas senor element 1 of this invention, greater in transverse sectional area than the second reference gas chamber 312.

The transverse sectional areas of the first and second reference gas chambers 311 and 312 of each of the test samples are listed in table 1 below. In table 1, “O” indicates the test samples in which the activation time is shorter than that of the test sample No. 1, and “X” indicates the test samples in which the activation time is longer than that of the test sample No. 1.

TABLE 1

| Test | 1^{st} chamber | 2^{nd} chamber | Activation | |
|---|---|---|---|---|
| Sample | sectional area | sectional area | Time (sec.) | Evaluation |
| No. 1 | S | S | 5.1 | — |
| No. 2 | 0.8 × S | 1.2 × S | 3.5 | ◯ |
| No. 3 | 0.8 × S | 1.0 × S | 4.2 | ◯ |
| No. 4 | 1.0 × S | 1.2 × S | 4.4 | ◯ |
| No. 5 | 1.2 × S | 0.8 × S | 6.4 | X |
| No. 6 | 1.0 × S | 0.8 × S | 5.4 | X |
| No. 7 | 1.2 × S | 1.0 × S | 5.8 | X |

Table 1 shows that the test samples No. 2 to No. 4 are faster in activation than the test sample No. 1, and the test samples No. 5 to No. 7 in which the first reference gas chamber 311 is greater in transverse sectional area than the second reference gas chamber 312 are slower in activation than the test sample No. 1. Table 1 also shows that in the test samples No. 2 to No. 4 having the structure of the invention, the smaller the transverse sectional area of the first reference gas chamber 311, and the greater the transverse sectional area of the second reference gas chamber 312, the shorter the activation time will be.

The inventor also performed tests to measure a difference in the activation time between two types of gas sensor elements: one, as illustrated in FIG. 33(a), in which the reference gas chamber 3 is not formed in the non-heating area 22 and the other, as illustrated in FIG. 33(b), in which the reference gas chamber 3 is formed in the non-heating area 22. The activation time of each of the test samples were measured in the same manner as described above.

Test sample No. 1 of the first type, as illustrated in FIG. 33(a), was prepared. Test samples No. 2 and 3 of the second type, as illustrated in FIG. 33(b), were prepared.

The transverse sectional area of the reference gas chamber 3 of each of the test samples are listed in table 2 below.

TABLE 2

| | Reference | | |
|---|---|---|---|
| Test | gas chamber | Activation | |
| Sample | sectional area | Time (sec.) | Evaluation |
| No. 1 | — | 3.7 | — |
| No. 2 | 0.90 mm² | 3.2 | ◯ |
| No. 3 | 1.04 mm² | 3.0 | ◯ |

Table 2 shows that the test samples No. 2 and No. 3 are faster in activation than the test sample No. 1 and that the greater the transverse sectional area of the reference gas chamber 3, the shorter the activation time will be.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

What is claimed is:

1. A gas sensor element comprising:
an oxygen ion conductive solid electrolyte member;
a measurement gas electrode which is affixed to one of opposed surfaces of said solid electrolyte member and exposed to a gas to be measured;
a reference gas electrode affixed to the other of the opposed surfaces of said solid electrolyte member;
a heater equipped with a heating element working to heat said solid electrolyte member; and
a reference gas chamber defined between said solid electrolyte member and said heater, said reference gas chamber being filled with a reference gas to which said reference gas electrode is exposed, said reference gas chamber having a length made up of a first chamber and a second chamber, the first chamber being located in a heating area in which the heating element of said heater is disposed, the second chamber being located in a non-heating area and having at least a portion which is greater in volume per unit length of said reference gas chamber than the first chamber.

2. A gas sensor element as set forth in claim 1, wherein the first chamber has a maximum transverse sectional area which is smaller than that of the second chamber.

3. A gas sensor element as set forth in claim 1, wherein an average of transverse sectional areas along a length of the first chamber is smaller than that of the second chamber.

4. A gas sensor element comprising:
an oxygen ion conductive solid electrolyte member;
a measurement gas electrode which is affixed to one of opposed surfaces of said solid electrolyte member and exposed to a gas to be measured;
a reference gas electrode affixed to the other of the opposed surfaces of said solid electrolyte member;
a heater equipped with a heating element working to heat said solid electrolyte member; and
a chamber defined between said solid electrolyte member and said heater, said chamber being located in a non-heating area which lies outside a heating area in which the heating element of said heater is disposed.

5. A gas sensor element as set forth in claim 4, further comprising a pumping reference function working to feed a reference gas to said reference gas electrode through said solid electrolyte member.
